(19) United States
(12) Patent Application Publication
(10) Pub. No.: US 2003/0008639 A1
(43) Pub. Date: Jan. 9, 2003

(54) Tele-interpretation

(76) Inventor: Takayuki Kanegae, Sagaken (JP)

Correspondence Address: Takayuki Kanegae, 2-24-11 keyakidai kiyama-mahi, Saga-ken, JP

(21) Appl. No.: 09/898,970

(22) Filed: Jul. 5, 2001

(51) Int. Cl. H04M 3/42

(52) U.S. Cl. 455/414; 455/425

(57) ABSTRACT

You can ask a telecommuting interpreter for translation at anytime and anywhere using a special cellular phone.

Or you can apply to an exchange center to transfer to a telecommuting interpreter.

### BACKGROUND OF THE INVENTION

Present invention is Tele-interpretation.

For the time being, an interpreter is always at the same place with the speaker, therefore, handicapped person or people who cannot walk are unable to perform interpretation. This invention will enable them to perform interpretation.

### BRIEF DESCRIPION OF THE DRAWINGS

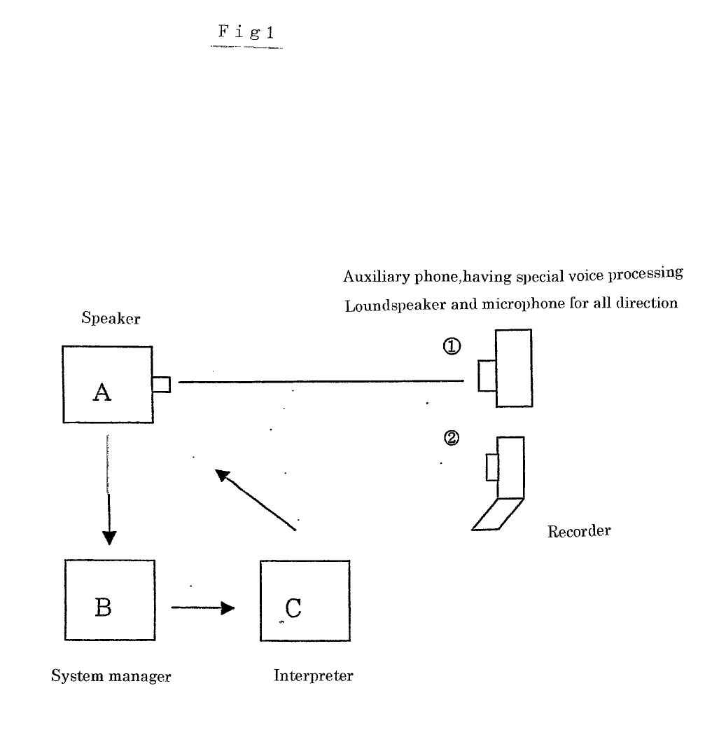

A prefered form of the present invention is Illustrated in the accompanying drawings in which FIG. 1. is a view in perspective of a preferred Embodiment or this invention.

### DETAILED DESCPIPTION OF THE INVENTION

Explaining the drawings in more detail.

Speaker A who needs interpretation calls system manager B to apply for interpretation. B transfers A to interpreter C. C interprets for A by phone from any random place, or C contacts A directly, without the intermediary B.

\mathring{1} is an auxiliary phone, having special voice processing and no dial buttons, of which the parent phone is possessed by A within the range of feeble radio waves.

\mathring{2} is a recorder connected to \mathring{1} or a parent phone, and this is used to record the system.

\mathring{1} and \mathring{2} are unnecessary if a parent phone contains the functions \mathring{1} and \mathring{2}.

What is claimed is:

1. Tele-interpretation using a cellular phone

2. A special cellular phone having a high quality microphone and speaker to perform #1

3. Telephone exchange with multiple transfer function to perform #1
